(19) United States
(12) Patent Application Publication
(10) Pub. No.: US 2016/0253887 A1
(43) Pub. Date: Sep. 1, 2016

(54) PLUSH SAFETY DEVICE

(71) Applicant: Cameron Webb, Redondo Beach, CA (US)

(72) Inventor: Cameron Webb, Redondo Beach, CA (US)

(21) Appl. No.: 14/633,440

(22) Filed: Feb. 27, 2015

(51) Int. Cl. G08B 17/117; H04M 1/725; G08B 5/36; G08B 21/12

(52) U.S. Cl. CPC G08B 17/117; G08B 21/12; H04M 1/7253; H04M 1/72538; G08B 5/36

(57) ABSTRACT

A plush safety device includes a plush outer shell stuffed with a filler. The plush outer shell forms an inside cavity. An electronics module is held within the inside cavity. The electronics module also includes a processor and a memory. A microphone is connected to the electronics module. The microphone records ambient sounds and stores ambient sounds in the memory. A smoke detector is also attached to the plush outer shell. The smoke detector has a preset smoke threshold above which, a smoke detector alarm is activated. The carbon monoxide detector is also attached to the plush outer shell. The carbon monoxide detector has a preset carbon monoxide threshold. A Bluetooth module can be connected to a Bluetooth antenna.

### FIELD OF THE INVENTION

The present invention is in the field of plush, more specifically plush safety devices.

### DISCUSSION OF RELATED ART

Plush animals such as plush toy bears have been popular since Theodore Roosevelt popularized teddy bears during his presidency. Today, a variety of different plush toys provide a collector many opportunities to build a large collection. Plush toys have become very popular and have been featured in museum exhibits. Children enjoy plush toys everywhere. Some plush toys are also safety devices and include a smoke detector. For example, in the Nesbit reference entitled Toy With A Smoke Detector, U.S. Pat. No. 4,004,988, issued Feb. 27, 1990, the disclosure of which is incorporated herein by reference, inventor Charles Nesbit provides a teddy bear with a smoke detector.

### SUMMARY OF THE INVENTION

A plush safety device includes a plush outer shell stuffed with a filler. The plush outer shell forms an inside cavity. An electronics module is held within the inside cavity. The electronics module also includes a processor and a memory. A microphone is connected to the electronics module. The microphone records ambient sounds and stores ambient sounds in the memory. A smoke detector is also attached to the plush outer shell. The smoke detector has a preset smoke threshold above which, a smoke detector alarm is activated. The carbon monoxide detector is also attached to the plush outer shell. The carbon monoxide detector has a preset carbon monoxide threshold. A Bluetooth module can be connected to a Bluetooth antenna.

The plush safety device also includes a lamp. The processor is configured to activate the lamp when the smoke detector detects smoke above the preset smoke threshold, or when the carbon monoxide detector detects carbon monoxide above the preset carbon monoxide threshold. The plush safety device can also have a speaker mounted to the plush outer shell. The speaker is electronically connected to the electronics module.

plush safety device can also have a speaker mounted to the plush outer shell. The speaker is electronically connected to the electronics module.

The plush safety device also optionally has a smart phone and a cell phone application operating on the smart phone. The cell phone application is configured to activate a cell phone alarm. The Bluetooth module pairs with a cell phone Bluetooth module to establish a Bluetooth pairing. The cell phone alarm is activated when the Bluetooth pairing is interrupted. The cell phone application is configured to activate the cell phone alarm.

The plush safety device optionally includes a physical safety leash having a safety leash strap and a safety leash strap loop. The safety leash plug is configured to fit into a safety leash socket. The speaker can be made separately as an alarm speaker and an audio speaker. The video camera is preferably mounted to the plush outer shell and electronically connected to the electronics module so that the video camera records a video stream stored in the memory.

The plush safety device also optionally comprises a WiFi module electronically connected to the processor. A Wi-Fi antenna allows the Wi-Fi module to electronically connect to the Wi-Fi antenna to provide network connectivity to the plush safety device. A clothing accessory optionally fits over at least a portion of the plush outer shell. The plush safety device optionally also includes a radio transceiver connected to a radio antenna and a GPS receiver connected to a GPS antenna. The GPS receiver receives a GPS signal and transmits the GPS signal on the radio transceiver when the radio transceiver receives an incoming location request.

### BRIEF DESCRIPTION OF THE DRAWINGS

FIG. 1 is a perspective view of the present invention.

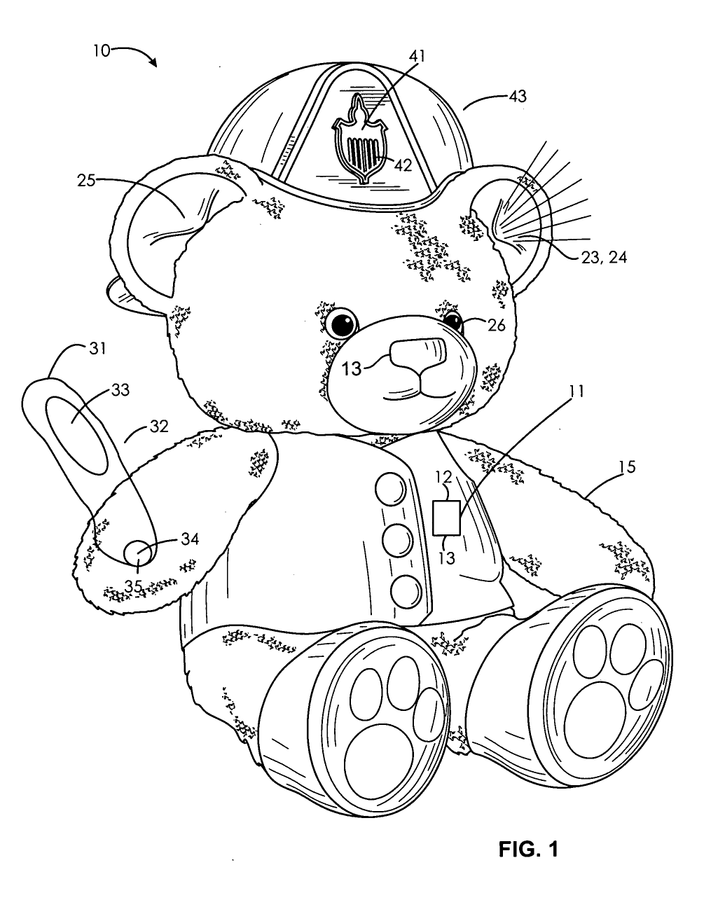

FIG. 2 is a diagram of a cross-section of the plush safety device.

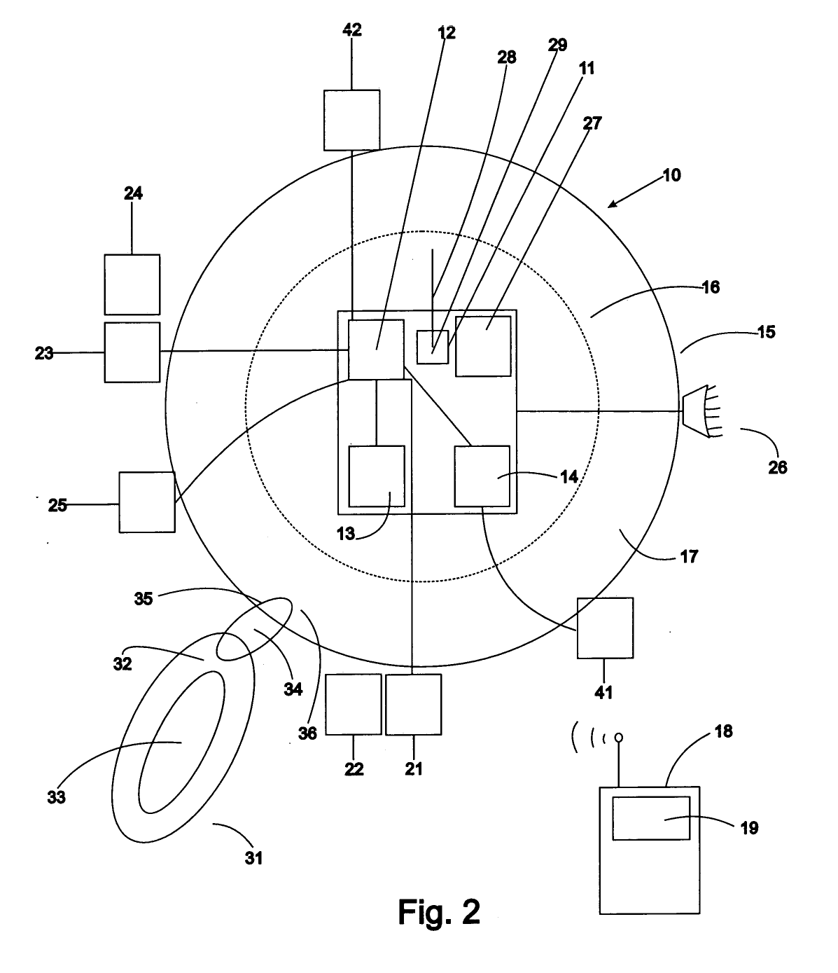

The following callout list of elements can be a useful guide in referencing the elements of the drawings.
10 Plush Safety Device
11 Electronics Module
14 Bluetooth Module
15 Plush Outer Shell
16 Inside Cavity
17 Filler
18 Smart Phone
19 Cell Phone Application
21 Smoke Detector
22 Carbon Monoxide Detector
23 Alarm Speaker
24 Audio Speaker
25 Microphone
26 Lamp
27 GPS Receiver
28 Antenna
29 Radio Receiver
31 Safety Leash
32 Safety Leash Strap
33 Safety Leash Strap Loop
34 Safety Leash Plug
35 Safety Leash Socket
36 Safety Leash Socket Housing
41 Video Camera
42 Wifi Module
43 Clothing Accessories

### DETAILED DESCRIPTION OF THE PREFERRED EMBODIMENT

A plush safety device 10 has a plush outer shell 15 constructed of fabric. The outer shell 15 fabric has a textile surface forming an outer layer of cut nap or pile. The pile of the outer shell can be backed by a cotton backing. Additionally, one or more yarns can accompany the outer layer of pile. Preferably, the fabric is a synthetic polyester.

The plush outer shell 15 covers and encloses an inside cavity 16. The inside cavity is partially stuffed with a filler 17 such as soft stuffing, or alternatively fillers such as sand or beads. The inside cavity 16 can encapsulate and have an electronics module 11. The electronics module 11 can hold a processor 12 for receiving inputs from sensors and for outputting outputs at lamps and speakers. The processor 12 may have access to memory 13 for storing a variety of recordings. The memory 13 can be a flash memory such as a removable micro SD.

The outer shell can have sensors embedded within the outer shell fabric. The sensors can be attached to an opening of the outer shell fabric. The outer shell fabric preferably has an area of pile that is tapered to a lower profile so as to avoid blocking the sensor.

An integrated smoke detector 21 can provide a warning in the event of smoke or fire. The smoke detector 21 can be mounted on the outer shell 15 fabric at an opening of the other shell 15 fabric. The integrated smoke detector 21 may have a housing that connects to the outer shell fabric. The smoke detector can have a variable sensitivity adjustment. The smoke detector can be monitored by the processor to provide an output. The processor can provide an output of activating another component such as a radio module.

Also, a carbon monoxide detector 22 can detect dangerous inhalation levels and can also as a carbon monoxide meter for recording historical levels of carbon monoxide. The carbon monoxide detector 22 detects dangers such as car exhaust, leaking appliances and the like. The smoke detector 21 and the carbon monoxide detector 22 can share a common housing. The carbon monoxide levels can be monitored by the processor 12 and stored in a log file in the memory 13.

An audible alarm can sound if dangerous conditions are detected. The alarm can be output using an alarm speaker 23. The alarm speaker 23 can be different than or the same speaker as an audio speaker 24. The audible alarm can be triggered when the integrated smoke detector 21 or the carbon monoxide detector 22 is triggered at a preset threshold.

A microphone 25 can be provided for recording a voice message. The microphone 25 can be connected to the processor 12 and the processor 12 can output a sound file to the memory 13. The memory can be a flash memory that allows playback on the sound file to the user. The sound file can be a recording of a parent giving the child emergency fire instructions in case of fire. The emergency fire instructions sound file stored on the memory can be played back when the processor 12 receives a signal from the smoke detector 21 or the carbon monoxide detector 22.

A lamp 26 such as LED elements embedded within the eyes of the plush animal can activate upon an alarm. The LED elements can flash to signal an alarm, and the LED elements can also provide the user a steady light in a dark or smoke filled hazardous condition. The LED elements can also act as a beacon for search and rescue.

A GPS receiver 27 can be connected to the processor 12 to provide location tracking for monitoring activity. Location identification can be remotely activated for search and rescue. Remote activation may require a radio connection to the processor such as by an antenna 28 and radio receiver 29. The radio receiver can be a low-frequency long-range receiver that receives a signal such as a series of pulses from a radio emitter. The frequency of the radio receiver can be tuned to the 870-950 MHz band range for example.

A safety leash 31 is optionally included for providing a physical connection to a child. The safety leash has a strap 32 portion optionally including a safety strap loop 33 that can connect to a child's arm or wrist. The safety leash has a safety leash plug 34 that fits into a safety leash socket 35. The safety leash socket is formed on the outer shell. The safety leash socket can have a safety leash socket housing 36 with a flange. The safety leash socket housing preferably includes a switch to sense the unplugging of the plug from the safety leash socket. The switch is connected to the processor. The processor can sense a state of the safety leash socket as being plugged, or unplugged.

A Bluetooth module 14 can provide a Bluetooth connection between a handset such as a smart phone 18 of an adult running an application. When the Bluetooth pairing connection is interrupted, the cell phone of the adult which can be the smart phone 18 can receive a notice that the Bluetooth connection is interrupted. This can be used to alert the adult that the plush safety device has traveled far enough away from the smart phone 18 of the adult that the Bluetooth connection has been interrupted. The cell phone application 19 can be implemented on a smart phone 18 for example to provide a beep when Bluetooth connection has failed due to distance. A Bluetooth connection could also be used for transferring audio or video or other data between the smart phone 18 and the plush safety device 10.

A change of state from a plugged state of the safety leash socket to an unplugged state of the safety leash socket can activate in the audible alarm at the alarm speaker. The processor can also send a remote dial to a remote phone such as the smart phone 18 when a leash detachment data signal is detected.

The plush outer shell can also have a video camera 41 for remote surveillance. In conjunction with the microphone 25, the plush safety device can be used for monitoring children or babysitters. A WiFi module 42 can be connected to the processor 12. The video camera feed can also be wirelessly connected by standard WiFi wireless data transfer standards for streaming video monitoring of children. When connected to WiFi, the processor can be part of a computer such as a Linux or Android platform that has an IP address. A Bluetooth connection can also be used for providing an IP address. The WiFi module 42 thus allows a connection to the smart phone 18 so that the cell phone application 19 can establish a wireless connection to the video camera 41 and the microphone 25 of the plush safety device 10.

A variety of different clothing accessories 43 can be provided for the plush safety device. Clothing accessories can include themed accessories such as fireman's hat, or a policeman's hat. The themed accessories can be made of plastic injection molded members attached to the plush outer shell. The themed accessories can also house some of the sensors such as the smoke detector or the carbon monoxide detector.

A child can learn operation of the plush safety device from character themed storybooks and videos. Additionally, the plush safety device can also have an audio speaker to provide a recorded narrative.

1. A plush safety device comprising:
a. a plush outer shell stuffed with a filler, wherein the plush outer shell forms an inside cavity;
b. an electronics module held within the inside cavity, wherein the electronics module also includes a processor and a memory;
c. a microphone connected to the electronics module, wherein the microphone records ambient sounds and stores ambient sounds in the memory;
d. a smoke detector, wherein the smoke detector has a preset smoke threshold;
e. a carbon monoxide detector, wherein the carbon monoxide detector has a preset carbon monoxide threshold;
f. a Bluetooth module connected to a Bluetooth antenna;
g. a lamp, wherein the processor is configured to activate the lamp when the smoke detector detects smoke above the preset smoke threshold, or when the carbon monoxide detector detects carbon monoxide above the preset carbon monoxide threshold; and
h. a speaker, wherein the speaker is electronically connected to the electronics module.

2. The plush safety device of claim 1, further comprising:
a. a smart phone; and
b. a cell phone application operating on the smart phone, wherein the cell phone application is configured to activate a cell phone alarm, wherein the Bluetooth module pairs with a cell phone Bluetooth module to establish a Bluetooth pairing, wherein the cell phone alarm is activated when the Bluetooth pairing is interrupted; and
c. wherein the cell phone application is configured to activate the cell phone alarm.

3. The plush safety device of claim 1, further comprising:
a. a safety leash having a safety leash strap and a safety leash strap loop; and
b. a safety leash plug configured to fit into a safety leash socket.

4. The plush safety device of claim 1, wherein the speaker is an alarm speaker.

5. The plush safety device of claim 1, wherein the speaker is an audio speaker.

6. The plush safety device of claim 1, further comprising a video camera mounted to the plush outer shell and electronically connected to the electronics module wherein the video camera records a video stream stored in the memory.

7. The plush safety device of claim 1, further comprising a WiFi module electronically connected to the processor; and a Wi-Fi antenna wherein the Wi-Fi module is electronically connected to the Wi-Fi antenna to provide network connectivity to the plush safety device.

8. The plush safety device of claim 1, further comprising: a clothing accessory, wherein the clothing accessory fits over at least a portion of the plush outer shell.

9. The plush safety device of claim 1, further comprising:
a. a radio transceiver connected to a radio antenna; and
b. a GPS receiver connected to a GPS antenna, wherein the GPS receiver receives a GPS signal and transmits the GPS signal on the radio transceiver when the radio transceiver receives an incoming location request.

10. The plush safety device of claim 9, further comprising:
a. a smart phone; and
b. a cell phone application operating on the smart phone, wherein the cell phone application is configured to activate a cell phone alarm, wherein the Bluetooth module pairs with a cell phone Bluetooth module to establish a Bluetooth pairing, wherein the cell phone alarm is activated when the Bluetooth pairing is interrupted; and
c. wherein the cell phone application is configured to activate the cell phone alarm.

11. The plush safety device of claim 9, further comprising:
a. a safety leash having a safety leash strap and a safety leash strap loop; and
b. a safety leash plug configured to fit into a safety leash socket.

12. The plush safety device of claim 9, wherein the speaker is an alarm speaker.

13. The plush safety device of claim 9, wherein the speaker is an audio speaker.

14. The plush safety device of claim 9, further comprising a video camera mounted to the plush outer shell and electronically connected to the electronics module wherein the video camera records a video stream stored in the memory.

14. The plush safety device of claim 9, further comprising a video camera mounted to the plush outer shell and electronically connected to the electronics module wherein the video camera records a video stream stored in the memory.

15. The plush safety device of claim 9, further comprising a WiFi module electronically connected to the processor; and a Wi-Fi antenna wherein the Wi-Fi module is electronically connected to the Wi-Fi antenna to provide network connectivity to the plush safety device.

16. The plush safety device of claim 9, further comprising: a clothing accessory, wherein the clothing accessory fits over at least a portion of the plush outer shell.
